(19) United States
(12) Patent Application Publication
(10) Pub. No.: US 2004/0177662 A1
(43) Pub. Date: Sep. 16, 2004

(54) Lock removal tool

(76) Inventor: Michael W. Bosse, Bardstown, KY (US)

Correspondence Address: Richard C. Litman, LITMAN LAW OFFICES, LTD., P.O. Box 15035, Arlington, VA, 22215, US

(21) Appl. No.: 10/658,338

(22) Filed: Sep. 10, 2003

Related U.S. Application Data
(63) Continuation-in-part of application No. 10/387,513, filed on Mar. 14, 2003, now abandoned.

(51) Int. Cl. E05B 63/00

(52) U.S. Cl. 70/465

(57) ABSTRACT

The lock removal tool is a forcible entry tool designed to facilitate forcible entry through a locked door or other barricaded entryway during an emergency situation. The lock removal tool comprises an elongated bar having a lock cutting tool on one end and a tool piece, such as a screwdriver or Allen wrench, extending from the other end. A slide hammer mechanism having first and second impact collars fixed near the ends of the bar and a weight slidably disposed on the bar between the impact collars allows a significant force to be imparted to the lock cutting tool. The lock cutting tool itself is a flat metal plate with a bifurcated leading edge, the bifurcation forming a lock cutting slot. The leading edge is tapered to allow the lock cutting tool to be inserted underneath a door knob or lock face plate.

### CROSS-REFERENCE TO RELATED APPLICATION

This application is a continuation-in-part of U.S. patent application Ser. No. 10/387,513, filed Mar. 14, 2003.

### BACKGROUND OF THE INVENTION

1. Field of the Invention

The present invention relates to impact tools for emergency entry. More specifically, the invention is a lock removal tool using a sliding impact weight to drive a cutting tool underneath a doorknob or deadbolt for removal of the doorknob or deadbolt. The tool is also useful for removal of security bars over windows and doors, as well as for prying open doors, windows, vehicle doors and trunks, and more.

2. Description of the Related Art

In an emergency situation, fast access into a building, room, vehicle, or other closed space may be critical. A locked door may seal the path of firemen or a rescue crew responding to an emergency call. Police may encounter a locked or barricaded door, hindering their attempt to capture a criminal suspect or intervene in a crime in progress. The ability of emergency responders, whether police, firemen or others, to quickly gain entry in such a situation bears significantly on their success.

Various devices have been used to gain forcible entry into buildings and through locked doors. Fire crews and police carry battering rams, pry bars, lock cutting and removal tools, and other devices. Additionally, similar tools are often needed to remove security bars from a window, to gain entry into interior spaces of an automobile, and for other related tasks.

U.S. Pat. No. 3,219,316, issued to E. Fried on Nov. 23, 1965, discloses a forcible entry tool. The tool has two working units, each of the units having a head and a handle. The units may be joined together and carried and operated as a single unit, or separated and used separately, or separated for use individually and rejoined for use in a different configuration. The head on one of the units is essentially an axe having a blade and a pike. The head on the other unit is a slotted wedge, configured for prying. This device provides useful tools for obtaining a forcible entry, but the need to separate the two units and reconfigure the tool for special purposes is time consuming, and may cost excessive time during an emergency circumstance where time is of the essence.

U.S. Pat. No. 6,318,228, issued on Nov. 20, 2001 to J. Thompson, discloses a forcible entry device that uses a firearm secured to a hollow cylindrical housing to drive an interchangeable tool bit. The device is useful for forcing locked doors open, and for performing similar tasks. However, the device is not well suited for prying and other functions that may be necessary during an emergency where a forced entry must be made through a barricade that cannot be readily opened by the device's tool bit.

U.S. Pat. No. 3,568,657, issued on Mar. 9, 1971 to L. Gue, discloses a rock-breaking tool. The rock-breaking tool is an elongated bar having a chisel point on one end, and a chisel edge on the other end. Collars are located along the bar, and a hammer member is slidably mounted on the bar between the collars. The tool functions by placing an end of the bar on a piece of rock to be broken, and sliding the hammer to impact one of the collars. The hammer, impacting the collar, transmits a force to the bar's chisel end, breaking the piece of rock. A tool such as this could find application to a forced entry situation. However, the rock-breaking tool lacks features that would improve the tool's ability to break away or remove a door lock. Additionally, the tool is not well adapted for prying a door, window bars, vehicle closures, and the like.

U.S. Des. Pat. No. Des. 272,712, issued on Feb. 21, 1984 to S.R. Allen, discloses a combined slide hammer nail puller and building wrecking tool. The tool illustrated, however, is not well suited for driving a prying or cutting tool for door knob or lock removal. Additionally, the tool lacks specialized features for door knob or lock removal and entry.

None of the above inventions and patents, taken either singly or in combination, is seen to describe the instant invention as claimed. Thus a lock removal tool solving the aforementioned problems is desired.

### SUMMARY OF THE INVENTION

The lock removal tool is a slide-hammer impact tool particularly adapted for obtaining a forcible entry into a building or closed space by employing and combining techniques of lock removal, prying, and simple force.

The lock removal tool has a lock cutting tool for a door lock disposed on one end of an elongated bar. The lock cutting tool includes a cutting slot adapted to facilitate the removal of a door lock, or the removal of a doorknob from the door lock. On the other end of the bar is a blade similar to a screwdriver blade that is useful to manipulate and open a door lock mechanism once the doorknob has been removed.

An impact collar is fixed near each end of the bar. A sliding weight is slidably mounted on the bar between the impact collars so that the sliding weight may be moved along the bar to impact an impact collar, imparting a force to the tool at the end of the bar.

A locked door may be opened with the lock removal tool by placing the lock cutting fork against the door surface next to the door lock or door knob. By moving the sliding weight to impact the impact collar, the cutting fork is forced underneath the door knob or door lock, breaking it away from the door. With the door knob or door lock removed from the door, the door lock or latch mechanism may be manipulated with the screwdriver blade to open the door.

Additionally, the lock cutting tool is adapted for prying to facilitate entry into a closed space. The lock cutting tool is further adapted to engage a security bar in order to facilitate the forceful removal of the security bar.

Accordingly, it is a principal object of the invention to provide a lock removal tool.

It is another object of the invention to provide a lock removal tool that combines the function of several tools into a single tool.

It is a further object of the invention to provide a lock removal tool that includes a tool for forcibly removing a lock or doorknob from a door and a tool for manipulating the lock mechanism to open the door.

Still another object of the invention is to provide a lock removal tool that includes a prying tool.

Yet another object of the invention is to provide a lock removal tool that facilitates the forceful removal of security bars.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is perspective view of a lock removal tool according to the present invention.

FIG. 2 is a side view of a lock removal tool according to the present invention.

FIG. 3 is a front view of a lock removal tool according to the present invention.

FIG. 4 is a top plan view of a lock removal tool according to the present invention.

FIG. 5A is an exploded side view of the top end of a lock removal tool according to the present invention, showing a set screw for retaining a blade within a receptacle formed in the end of the lock removal tool.

FIG. 5B is a front view of the top end of a lock removal tool according to the present invention, showing the blade retained by the set screw.

FIG. 6 is an environmental, front view of the bottom end of a lock removal tool according to the present invention showing the lock cutting tool placed behind a doorknob face plate.

FIG. 7 is an environmental, side view of the bottom end of a lock removal tool according to the present invention, showing the lock cutting tool placed behind a doorknob face plate.

FIG. 8A is a perspective view of the bottom end of a lock removal tool according to the present invention, showing grooves formed in a top surface of the cutting tool.

FIG. 8B is a perspective view of the bottom end of a lock removal tool according to the present invention, showing grooves formed in a bottom surface of the cutting tool.

FIG. 9 is a side view of the bottom end of a lock removal tool according to the present invention, showing the trailing edge of the lock cutting tool engaged with a round bar, such as a window security bar.

Similar reference characters denote corresponding features consistently throughout the attached drawings.

### DETAILED DESCRIPTION OF THE PREFERRED EMBODIMENT

The present invention is a lock removal tool, designated generally as 10 in the drawings. The lock removal tool 10 is an impact tool designed for emergency services for quick and easy lock removal on commercial and residential doors, with only minimal damage being inflicted to the doors.

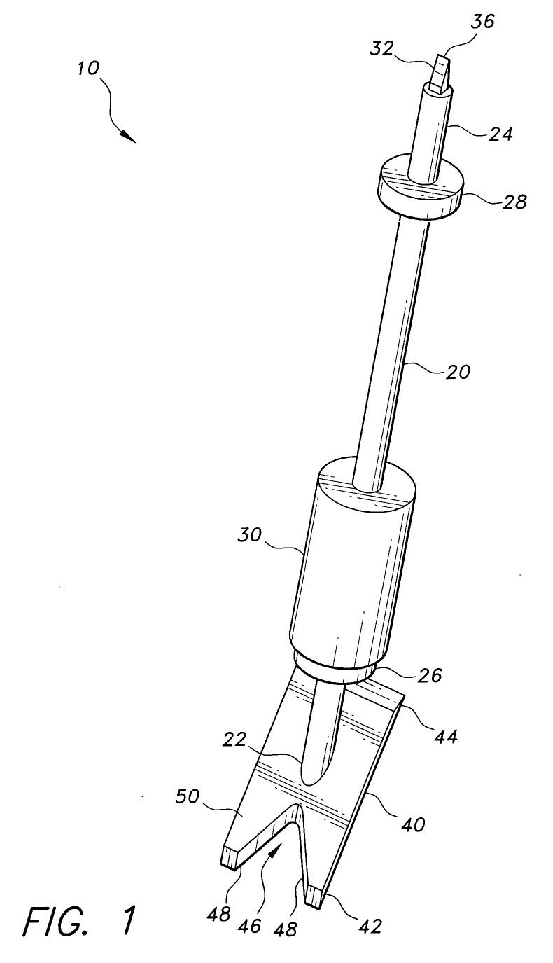

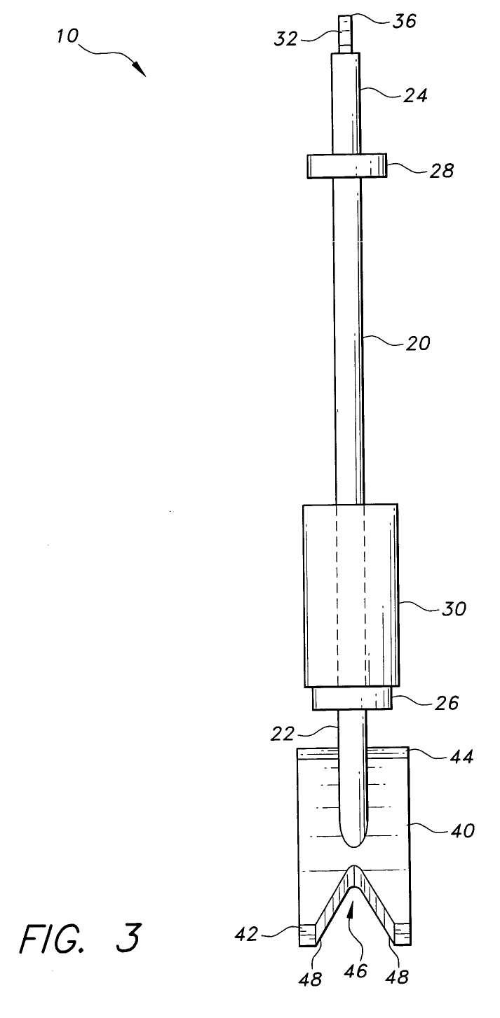

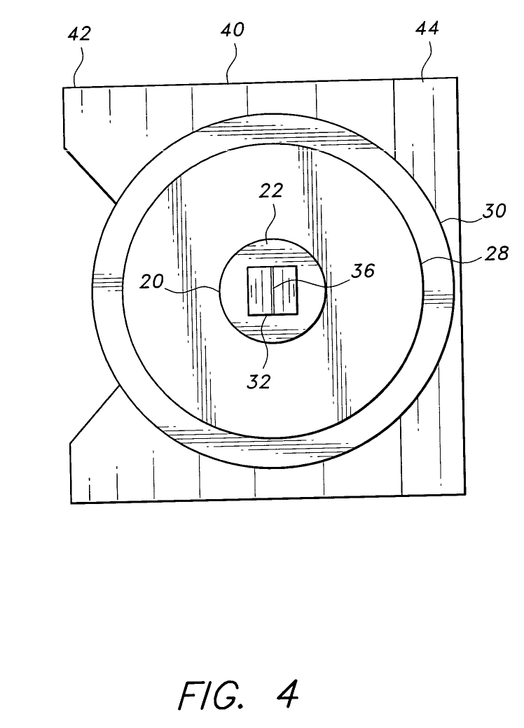

Referring to FIGS. 1-4, the lock removal tool 10 comprises an elongated bar 20 with a cutting tool end 22 and a disengaging tool end 24. A lock cutting tool 40 is attached to the cutting tool end 22 of the bar 20. A tool piece 32, such as a screwdriver blade, Allen wrench or the like, extends from the disengaging tool end 24 of the bar 20. Ideally the tool piece 32 is suited to manipulate a door's lock mechanism.

A slide hammer mechanism is formed along the bar 20, comprising a first impact collar 26 disposed on the bar 20 near the cutting tool end 22 of the bar 20, a second impact collar 28 disposed on the bar 20 near the disengaging tool end 24 of the bar 20, and a slide weight 30 slidably disposed on the bar 20 between the first impact collar 26 and the second impact collar 28. A similar slide hammer mechanism is disclosed in U.S. Pat. No. 3,568,657, incorporated herein by reference in its entirety. When slide weight 30 is moved quickly along the bar 20 to impact the first impact collar 26, the impact force is transferred to the bar 20 and to the lock cutting tool 40. The impact force is used to drive the lock cutting tool 40 behind a door knob or lock face to facilitate cutting or prying away the doorknob or lock face.

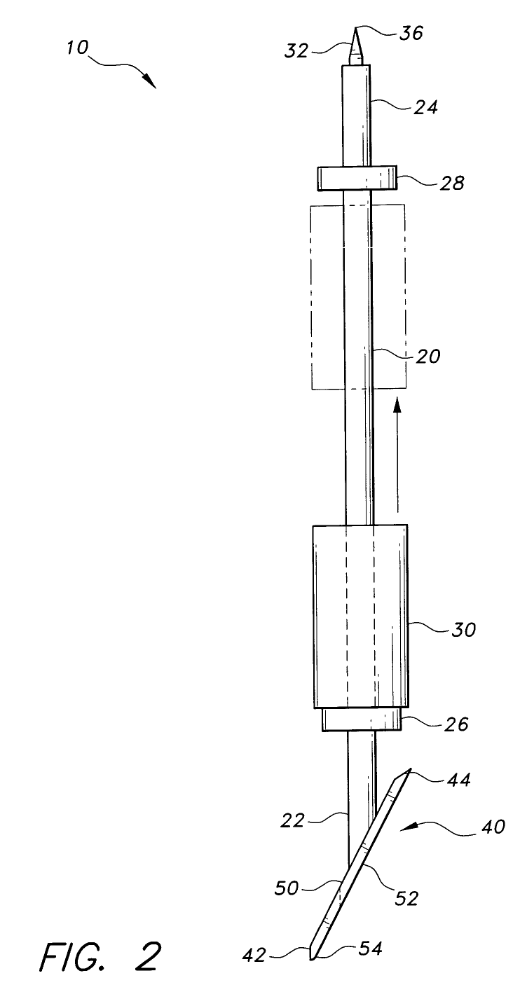

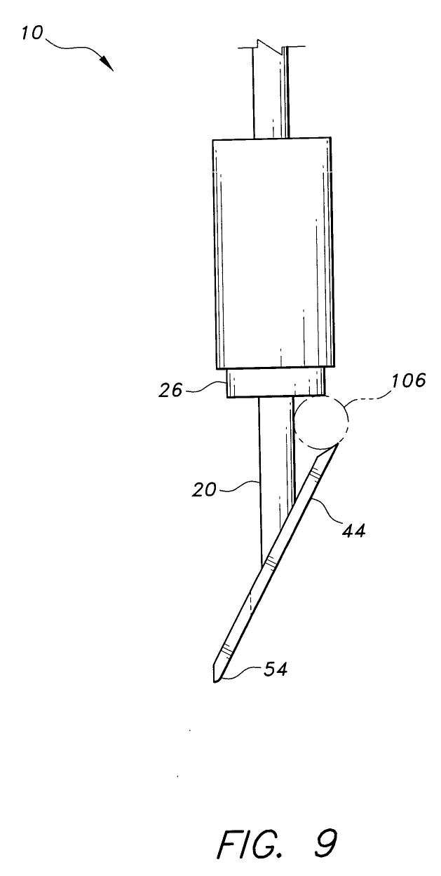

The lock cutting tool 40 itself is a generally rectangular, flat plate, preferably formed of a hardened steel, the flat plate having a top surface 50 and a bottom surface 52. The lock cutting tool 40 has a leading edge 42 and a trailing edge 44. The leading edge 42 is bifurcated to form a cutting slot 46. The cutting slot 46 is a generally “V” or “U” shaped slot formed in the leading edge 42 and defined by slot edges 48. The top surface 50 is tapered along the leading edge 42 and cutting slot edges 48 for cutting, and to facilitate insertion of the lock cutting tool 40 underneath a door knob or lock face. The bottom surface 52 has a slight curve 54 at the tip end along the leading edge 42, as seen in FIGS. 2 and 9, to minimize damage to a door surface as the lock cutting tool is inserted against the door surface underneath a door knob or lock face.

The cutting tool end 22 of the bar 20 is joined to the top surface 50 of the lock cutting tool 40, approximately between the cutting slot 46 and the trailing edge 44. The bar 20 extends rearward from the lock cutting tool 40, and is angled away from the top surface 50. The bar 20 and the lock cutting tool are joined at an angle of between 15° and 45°.

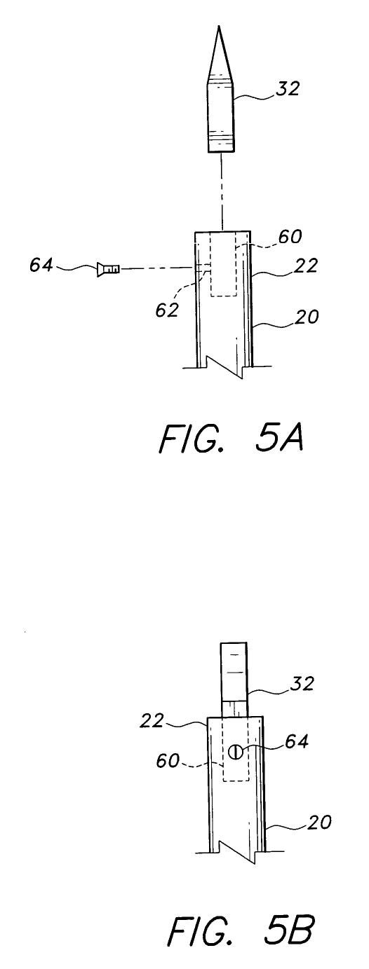

The tool piece 32 extends in line from the disengaging tool end 24 of the bar 20, and may be a tool such as a screwdriver blade or Allen wrench or the like. In the present embodiment, the tool piece 32 is a piece of square stock that is tapered to a blade 36 that is similar to a screwdriver blade. The tool piece 32 is preferably made from a soft steel, or other metal, that will bend rather than break under stress. The tool piece 32 is intended for insertion into a lock or door latch mechanism to operate the lock or door latch after the lock face or doorknob has been removed. In a preferred embodiment, shown in FIGS. 5A and 5B, the tool piece 32 is removable from the bar 20 so that it may be replaced if damaged. A receptacle 60 is formed in the disengaging tool end 24 of the bar 20 to receive the tool piece 32. A set-screw 64, threaded through a set-screw hole 62, holds the tool piece 32 in place.

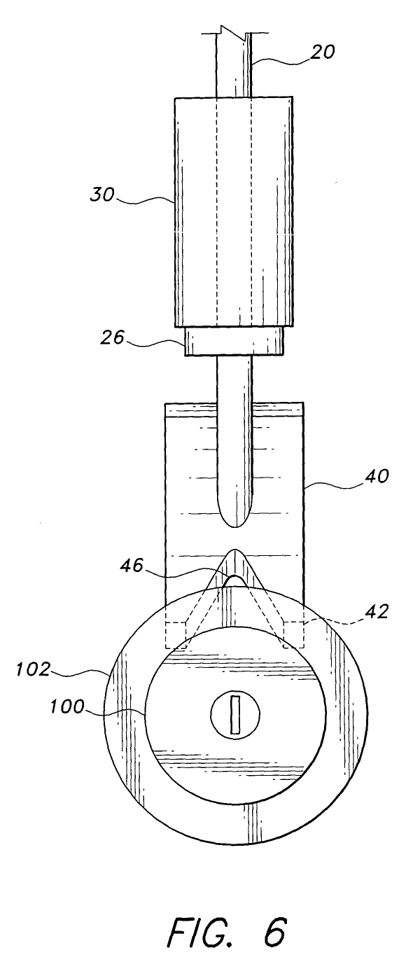

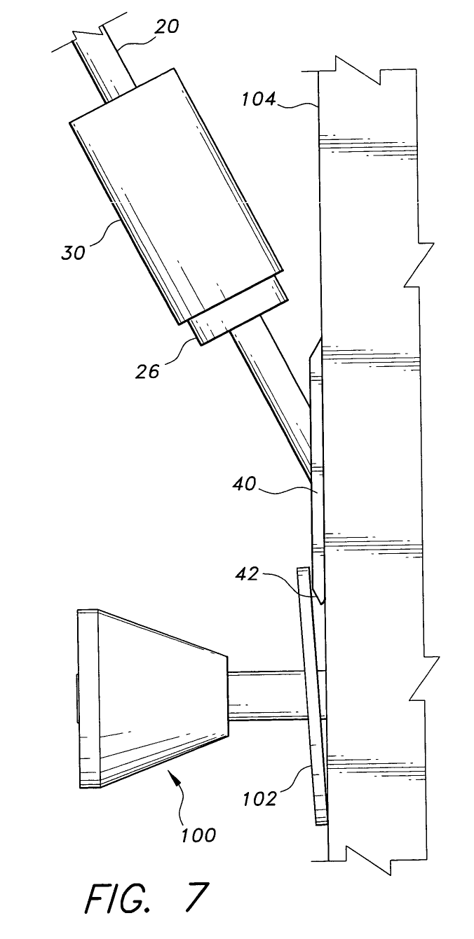

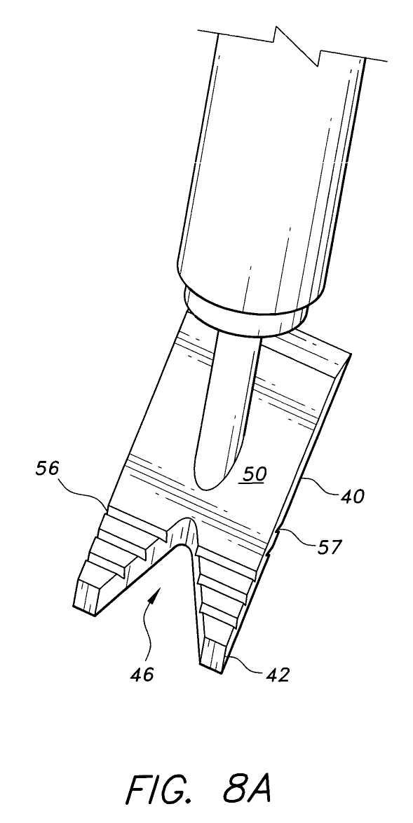

Turning to FIGS. 6 and 7, it can be seen that in use; the leading edge 42 of the lock cutting tool 40 is inserted underneath the face plate 102 of a door knob or lock 100, with the cutting slot 46 straddling the door knob or lock 100. Because the bar 20 is angled away from the lock cutting tool 40, the bar 20 and slide weight 30 are clear of a door or wall surface 104 for easy use, while a significant amount of impact force from the slide weight 30 striking the first impact collar 26 is directed toward the leading edge 42 of the lock cutting tool 40.

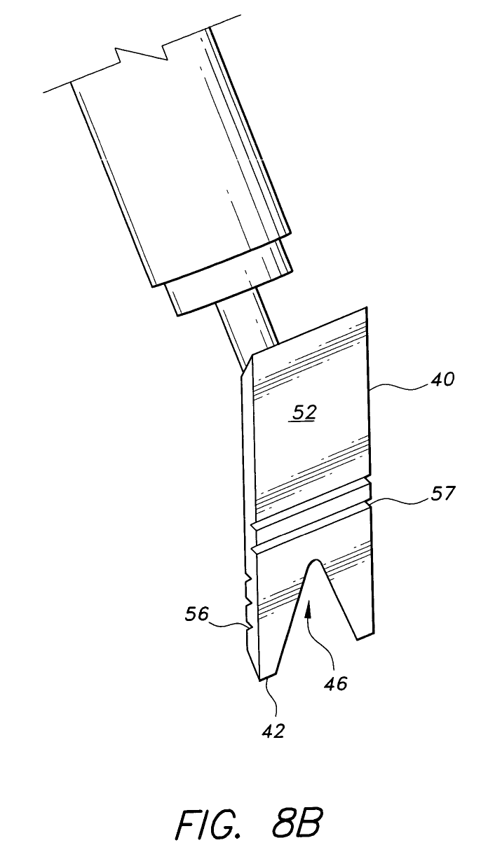

In an alternate embodiment of the cutting tool, shown in FIGS. 8A and 8B, grooves 56 are cut or formed in the top surface 50 of the cutting tool 40. The grooves 56 are located near the leading edge 42, extending transversely across the top surface 50 and across the cutting slot 46. Additionally, grooves 57 may be cut or formed in the bottom surface 52 and are preferably located generally behind the cutting slot 46.

As seen in FIG. 9, a space between the trailing edge 44, the bar 20 and the first impact collar 26 accommodates a metal bar 106 such as a metal window or door security bar, making the lock removal tool 10 useful for removing such security bars.

It can be appreciated that the lock removal tool 10 can be employed for a variety of prying functions in addition to lock removal, making the lock removal tool 10 very versatile for emergency forced entry situations.

It is to be understood that the present invention is not limited to the embodiment described above, but encompasses any and all embodiments within the scope of the following claims.

We claim:

1. A lock removal tool, comprising:
an elongated bar having a first end and a second end;
a lock cutting tool disposed on the first end of said bar, the lock cutting tool being a generally rectangular, flat plate having leading and trailing edges and top and bottom surfaces, said bar being joined to the lock cutting tool generally between the leading and trailing edges, said bar being angled away from the top surface and extending rearward from the lock cutting tool;
a tool piece extending from the second end of said bar axially aligned with said bar;
a first impact collar disposed on said bar near the first end;
a second impact collar disposed on said bar near the second end; and
a weight slidably disposed on said bar between the first and the second impact collar.

2. The lock removal tool according to claim 1, wherein said tool piece comprises a length of metal stock.

3. The lock removal tool according to claim 2, wherein said metal stock square.

4. The lock removal tool according to claim 3, wherein said metal stock is tapered to define a blade.

5. The lock removal tool according to claim 1, wherein the second end of said bar has a tool piece receptacle defined therein and a threaded set screw aperture formed through the bar and extending into the receptacle, the lock removal tool further comprising a set screw engaging the set screw aperture, whereby said tool piece is removably retained within said tool piece receptacle by said set screw.

6. The lock removal tool according to claim 1, wherein the leading edge of said lock cutting tool is bifurcated to form a cutting slot, the cutting slot being a generally “V” shaped slot having inner edges.

7. The lock removal tool according to claim 1, wherein said top surface of said lock cutting tool is tapered along the leading edge.

8. The lock removal tool according to claim 1, wherein the leading edge of said lock cutting tool is bifurcated to form a cutting slot, the cutting slot being a generally “V” shaped slot having inner edges, the top surface of said cutting tool being tapered along the inner edges of said cutting slot.

9. The lock removal tool according to claim 1, wherein the top surface of said lock cutting tool is tapered along the trailing edge.

10. The lock removal tool according to claim 1, wherein the bottom surface of said cutting tool is curved at the leading edge.

11. The lock removal tool according to claim 1, wherein said cutting tool has at least one groove formed in the top surface, the at least one groove extending transversely across the top surface.

12. The lock removal tool according to claim 1, wherein said cutting tool has at least one groove formed in the bottom surface, the at least one groove extending transversely across the bottom surface.

13. The lock removal tool according to claim 1, wherein said bar and said lock cutting tool are joined at an angle of between 15° and 45°.
